(19) United States
(12) Patent Application Publication
(10) Pub. No.: US 2013/0135862 A1
(43) Pub. Date: May 30, 2013

(54) Tubular Light Source with Light Emitting Diodes on End Portions and Light Reflecting Sheet

(71) Applicants: Chin Khew Leong, Penang (MY); Vincent Wu, Shanghai (CN); Frank Sheng, Shanghai (CN)

(72) Inventors: Chin Khew Leong, Penang (MY); Vincent Wu, Shanghai (CN); Frank Sheng, Shanghai (CN)

(73) Assignee: OSRAM OPTO SEMICONDUCTORS GMBH, Regensburg (DE)

(21) Appl. No.: 13/575,915

(22) PCT Filed: Jan. 27, 2011
(86) PCT No.: PCT/EP11/51150

§ 371 Date: Feb. 12, 2013

(30) Foreign Application Priority Data
Jan. 29, 2010 (CN) 201010104786.3

(51) Int. Cl. F21V 7/10

(52) U.S. Cl. CPC F21V 7/10
USPC 362/244; 362/235

(57) ABSTRACT

A light source includes a tube fixed to a first and a second end part. The tube has a lateral area. A part of the lateral area includes a light-outcoupling surface of the light source. At least one first light-emitting diode is mounted to the first end part and at least one second light-emitting diode is mounted to the second end part. Each of the first and the second light-emitting diode emitting light along a main direction of extent of the tube. A light reflecting sheet covers all interior surfaces of the tube except the light-outcoupling surface.

This patent application is a national phase filing under section 371 of PCT/EP2011/051150, filed Jan. 27, 2011, which claims the priority of Chinese patent application 201010104786.3, filed Jan. 29, 2010, each of which is incorporated herein by reference in its entirety.

### TECHNICAL FIELD

The invention relates to a light source.

### SUMMARY OF THE INVENTION

In one aspect, the invention specifies a light source comprising light-emitting diodes.

According to an embodiment of the invention, the light source comprises a tube which is fixed to a first end part and to a second end part and which is arranged between the first and second end part. The tube extends along a main direction of extent which is directed from the first end part to the second end part, wherein the first end part, the tube and the second end part define and enclose an inner volume.

Furthermore, the tube has a tube wall with a lateral area connecting the first end part to the second end part, wherein a part of the lateral area forms a light-outcoupling surface of the light source.

The light source further comprises at least one first light-emitting diode (LED) situated inside the inner volume of the light source and mounted to the first end part, and at least one second light-emitting diode situated inside the inner volume of the light source and mounted to the second end part. Each of the at least one first and at least one second light-emitting diode emits light along a main beam path, wherein the main beam path is oriented along the direction of the tube. In particular, the at least one first LED and the at least one second LED emit light in opposite directions, i.e., the at least one first LED emits light directed toward the second end part, whereas the at least one second LED emits light toward the first end part.

The main beam path denotes here and in the following the mean emission direction of the LEDs, wherein the LEDs may emit light for example with a Lambertian angular distribution or another angular distribution.

Further, the light source comprises a light reflecting sheet covering all interior surfaces of the tube except the light-outcoupling surface.

State-of-the-art tube-shaped LED lighting devices are known, which comprise a plurality of LEDs arranged along the direction of extent of the tube and emitting light toward a light-outcoupling surface of the tube. One variant of a known tube-shaped LED lighting device comprises low power LEDs with an optical power of about 0.06 to 0.5 W for each LED, whereas another variant of a known tube-shaped lighting device comprises high power LEDs with an optical power of about 0.5 to 1 W for each LED. The first, low power LED variant suffers from the disadvantage that each of the LEDs has a low optical efficacy. Thus, a high number of LEDs has to be used, resulting in high costs for such lighting device. The second, high power LED variant may have a higher optical efficacy so that less LEDs have to be used. However, for a given length of the tube-shaped lighting device the LEDs have to be placed at certain distances relative to each other so that the LEDs are discretely visible along the tube. This leads to undesirably inhomogeneous light emission characteristics and glaring even in devices where special covers are used on the light-outcoupling surface to avoid bright and dark spots, since commonly used diffusive covers cannot completely remove bright and dark spots on the light-outcoupling surface.

In contrast to the tube-shaped LED lighting devices known in the art, the light source according to present invention comprises the first and second LEDs which emit light directed along the main direction of extent of the tube. In other words, light emitted directly toward the light-outcoupling surface from an LED is significantly reduced or even avoided so that the disadvantages of the state of the art can be omitted. Due to the reflecting sheet covering all interior surfaces of the tube except the light-outcoupling surface, the light emitted by the first and second LEDs can be directed more homogeneously toward the light-outcoupling surface so that a more homogenous light emission can be achieved.

In a further embodiment each of the first and the second LED comprises a plurality of LEDs. In particular, a plurality of first LEDs may be mounted to the first end part and a plurality of second LEDs may be mounted to the second end part so that the intensity of the light which is emitted by the light source can be increased and adapted to a desired intensity. The plurality of LEDs may be arranged on the respective end part in one or in several groups formed by all or at least several of the plurality of LEDs.

Furthermore, the at least one first and/or the at least one second LED may comprise a lens, for example a silicone lens, which is suitable to adapt the light emitting characteristics of the LED. In case of a plurality of LEDs, each of the LEDs may have a lens. The LEDs preferably emit white light, for example warm-white or cold-white light, which is suitable for lighting purposes. Additionally or alternatively, at least on of the LEDs may emit colored light.

Preferably, the first and the second LED may have an optical power of more than 0.5 W and particularly preferably an optical power of about 1 W or even more. Since the first and the second LED emit light not directly to the light-outcoupling surface but mainly along the direction of extent of the tube, the LEDs are not directly observable through the light-outcoupling surface so that bright and dark spots are omitted compared to the state-of-the-art tube-like LED lighting devices.

In a further embodiment the reflecting sheet comprises a silver layer, as silver has a high reflectivity for light with visible wavelengths. In particular, the reflecting sheet may have a reflectivity of at least 95% for the light emitted by the first and second LEDs, preferably of at least 98% and particularly preferably of about 99%.

The reflecting sheet may be a flexible foil so that it can be formed to any desired shape and can cover arbitrarily formed interior surfaces of the tube. Advantageously, this may provide a high degree of flexibility for designing the light source and in particular the shape of the tube. Furthermore, plating or coating the tube and/or the end parts with a reflecting material can be avoided.

In particular, the reflecting sheet may be formed of a silver foil or of a plastic foil coated with a silver layer. Further, the reflecting sheet may comprise one or more sheets or foils. For example, the tube may have a cylindrical or a rectangular cross-section so that it may be a hollow cylinder or a hollow rectangular tube. In case of a tube with a rectangular cross-section the rear interior surface, i.e., the interior surface lying opposite to the light-outcoupling surface, and the interior sidewalls, i.e., the interior surfaces connection the rear interior surface to the light-outcoupling surface, may be covered by the reflecting sheet.

In a further embodiment, the tube comprises a rear part carrying the reflecting sheet so that the rear part is covered by the reflecting sheet. Furthermore, the tube may comprise a front part comprising the light-outcoupling surface. Thus, by fixing the rear part to the front part the tube of the light source can be formed. A two-part design of the tube may facilitate the manufacturing the tube, in particular covering of the interior surface with the reflecting sheet. The front part of the tube may be transparent or may have a transparent area forming the light-outcoupling surface. The rear part may be transparent or opaque.

Further, the tube or, in case of a two-part design of the tube, at least the front part of the tube may comprise a transparent plastic, for example polycarbonate or plexiglass, or glass or may be made of one of those materials.

Furthermore, the tube may be air-filled. This may imply that, advantageously, no special precautions have to be taken when manufacturing the light source, in particular it may be not necessary that the light source and in particular the tube is air-tight, that the light source has to be evacuated or that the tube has to be filled with special gases as for example inert gases.

In a further embodiment the first and the second end part each comprise a reflector-like indentation so that each of the end parts has a recess which is formed as a reflector cup and which carries the at least one first LED or the at least one second LED. In other words, the at least one first LED and the at least one second LED are mounted in the reflector-like indentation of the respective end part. Preferably, the indentations or recesses are adapted to the shape of the tube so that there is a smooth transition from the respective end part and its indentation to the tube.

Furthermore, the reflector-like indentations of the first and the second end parts may be covered by the reflecting sheet so that all interior surfaces of the light source except the light-outcoupling surface, which include all interior surfaces of the tube except the light-outcoupling surface together with the surfaces of the reflector-like indentations of the end parts, are covered by the reflecting sheet.

The reflector-like indentations may be formed to direct the light emitted by the LEDs along the main direction of extent of the tube, which may increase the homogeneity of the light emitted from the light-outcoupling surface of the tube.

In a further embodiment each of the first and the second end part comprises a heat sink. The respective heat sink may include a cooling body and may be mounted or fixed to the first or second end part, or may be integrally formed with the first or second end part. Advantageously, heat produced by the at least one first LED or the at least on second LED may be transferred to the first or second end part and may be further dissipated by the heat sinks to the surrounding environment so that an effective cooling of the LEDs can be provided. The heat sinks may comprise blades, ribs, fins or a combination thereof or other means which are suitable to increase the surface area of the heat sink in order to increase a heat transport from the heat sink to the surrounding environment.

The first and the second end part may comprise aluminum or may be made of aluminum. Alternatively, the first and second end part may be made of another material, which preferably has a high heat conductivity, as for example copper. Furthermore, in case the end parts comprise heat sinks, the heat sinks may be made of aluminum or of another material with a high heat conductivity, as for example copper.

In a further embodiment, the light-outcoupling surface comprises a diffusive or refractive sheet. The diffusive or refractive sheet may be positioned on and/or attached to the light-outcoupling surface and may be suitable to further homogenize the light emitted by the light source. The diffusive or refractive sheet can have scattering centers by which a spatial and/or angular distribution of light can be increased and/or randomized. By way of example, such scattering centers can be reflective or light-refractive. For example, scattering centers in the form of particles can be embedded in a transparent matrix, for instance composed of a plastic. As an alternative, scattering centers can also be formed by surface or interface structures, which can be either irregular or regular. Irregular structures can be formed for example by a roughness structure of a surface, while regular structures can have for example a microprism structuring.

In a further embodiment the light source further comprises an electronic control device for controlling the at least one first and second LEDs. The electronic control device, which has for example driver circuit, is expediently designed for controlling the LEDs of the light source. The control device can be embodied as a control chip, for instance as an IC chip, and can further provide suitable connectors for electrically connecting the light source to an external power source. The control device can be arranged within or outside the interior space formed by the tube and the end parts. Alternatively, the control device can be placed in a recess of an end part or a heat sink or on the outside of one of those elements.

Furthermore, the light source can include a standard T5 or T8 socket so that the light source can be used as replacement for conventional discharge tubes.

### BRIEF DESCRIPTION OF THE DRAWINGS

Further features, advantages and expediencies will become apparent from the following description of the exemplary embodiments in conjunction with the figures.

FIG. 1 shows a schematic view of a light source according to an embodiment of the invention; and

FIG. 2 shows a schematic view of an end part with a plurality of LEDs according to a further embodiment of the invention.

### DETAILED DESCRIPTION OF ILLUSTRATIVE EMBODIMENTS

Elements that are identical, of identical type and act identically are provided with identical reference symbols in the figures.

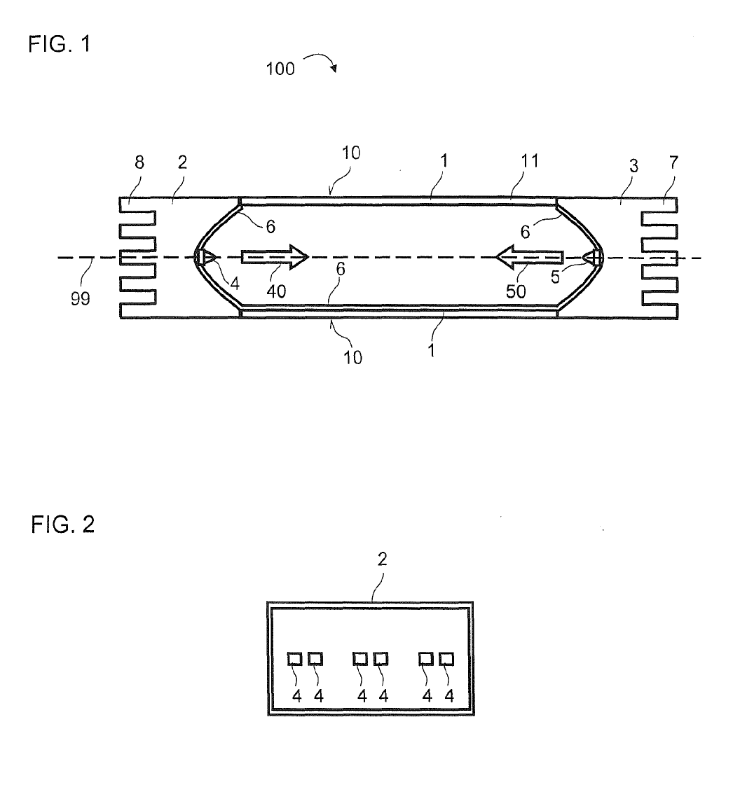

FIG. 1 shows a light source 100 which comprises a tube 1 which is arranged between a first end part 2 and to a second end part 3. The tube 1 extends along a main direction of extent as indicated by the dashed line 99 and has two openings to which the end parts 2, 3 are so that the tube 1, the first end part 2 and the second end part 3 define and enclose an inner volume.

The tube 1 has a tube wall which has a lateral area 10 forming an outer surface of the tube 1 and connects the first end part 2 to the second end part 3. A part of the lateral area 10 forms a light-outcoupling surface 11 of the light source 100, wherein the tube 1 is transparent at least in the region defined by the light-outcoupling surface 11.

Further, a light reflecting sheet 6 covers all interior surfaces of the tube 1 except the light-outcoupling surface 11. The light reflecting sheet 6 comprises a silver layer. In particular, the reflecting sheet 6 is a silver coated plastic foil, having a reflectivity of about 99% for visible light.

At least one first LED 4 and at least one second LED 5 are situated inside the inner volume of the light source 100. The at least one first LED 4 is mounted to the first end part 2 and, during operation, emit lights along a main beam path which is oriented along the direction of extent 99 of the tube 1 and which is indicated by arrow 40. The at least one second LED 5 is mounted to the second end part 3 and, during operation, also emits light along a main beam path which is oriented along the direction of extent 99 of the tube 1, which is indicated by arrow 50, so that the at least one first LED 4 and the at least one second LED 5 emit light in opposite directions, i.e., the at least one first LED 4 emits light directed toward the second end part 3, whereas the at least one second LED 5 emits light toward the first end part 2.

The main beam paths 40, 50 indicate the mean emission direction of the LEDs, wherein the LEDs may emit light for example with a Lambertian angular distribution or another angular distribution. In particular, a main beam path directed along the direction of extent 99 of the tube 1 implies that a part of the light emitted by the first and second LED 4, 5 can be emitted directly to the tube wall and therefore also directly toward the light-outcoupling surface.

The first and second LED 4, 5 emit white light, for example warm-white or cold-white light and have an optical power of about 1 W. Further features of the LEDs are described in connection with FIG. 2

The first and the second end part 2, 3 each have a reflector-like indentation where the first and second LEDs 4, 5 are mounted, respectively. As shown in FIG. 1, the reflecting sheet 6 covers the indentations of the end parts 2, 3.

Furthermore, the light source 100 has heat sinks 7, 8 made integrally with the end parts 2, 3, which can dissipate heat produced by the LEDs 4, 5 to the surrounding environment. The end parts 2, 3 and the heat sinks 7, 8 are made from aluminum.

Due to the reflecting sheet 6 covering all interior surfaces of the tube 1 and the reflector-like indentations of the end parts 2, 3 light emitted by the LEDs 4, 5 can be effectively randomized in the inner volume of the light source 100 so that the light source 100 emits light through the light-outcoupling surface with a homogeneous emission characteristic.

The light source 100 may further comprise an electronic control device for controlling the LEDs 4, 5 (not shown), which for example can be placed inside a recess of one of the heat sinks 7, 8 or next to one of the heat sinks 7, 8.

In order to improve the homogeneity of the light emitted through the light-outcoupling surface 11 one or several diffusive and/or refractive sheets can be positioned on the light-outcoupling surface 11 (not shown).

The tube 1 of the shown embodiment has a length of about 600 mm between the end parts 2, 3 and a rectangular cross-section, so that the light-outcoupling surface 11 is flat and the tube has two side-walls and a rear wall opposite to the light-outcoupling surface 11, which are covered by the reflecting sheet 6. In order to facilitate the manufacturing of the light source 100, the tube has two parts, i.e., a rear part consisting of the two side-walls and the rear wall and a front part which comprises the light-outcoupling surface 11 and which is fixed to the rear part. The tube 1 is made from a transparent plastic, for example polycarbonate or plexiglass. Alternatively, the tube 1 can be made of glass.

The light source 100 can include a standard T5 or T8 socket so that the light source can be used as replacement for conventional discharge tubes.

FIG. 2 shows an exemplary further embodiment of a first end part 2 for the light source 100 of FIG. 1 in more detail, seen along the direction of extent 99 of the tube 1 and opposite to the emission direction of the LEDs 4. The corresponding second end part 3 is similar to the first end part 2 of FIG. 2.

In the particular embodiment a plurality of six LEDs 4 are mounted in three groups of two LEDs 4 each. Each of the LEDs 4 has an optical output power of about 1 W so that a light source having two such end parts can emit light with an optical power of about 12 W. Such optical power was found to be suitable for example for a light source 100 having a tube length of about 600 mm. Each of the LEDs 4 are surface-mountable and have a silicone lens in order to adapt the emission characteristics. No further encapsulation or other optical means are need for the LEDs 4. By way of example, LEDs of the type OSLON (Manufacture: OSRAM Opto Semiconductors GmbH), are suitable therefore. The LEDs can be designed for generating mixed-colored or, in particular, white light. Each of the LEDs has a surface area of about 3 mm×3 mm.

Further, as can be seen from FIG. 2, the end part 2 has a rectangular shape which is adapted to the rectangular tube 1 described in connection with FIG. 1 which has a cross-section of the same dimensions. The end part 2 has a reflector-like indentation as shown in FIG. 1, wherein the plurality of LEDs is mounted and which is covered by the reflecting sheet. The reflector-like indentation of the end part 2 has a parabolic cross-section perpendicular to the longer side of the rectangle with a depth of about 25 mm and a height of about 20 mm, corresponding to the shorter side of the rectangle.

The light source 100 according to the embodiments shown in the Figures can include further or alternative features or combinations thereof as described in the general part of the description.

Due to the hollow tube the light source of the present invention provides an “air guide” technology with high power LEDs and a specially designed optical system including the reflecting sheet in order to provide a uniform and homogeneous light emission via the light-outcoupling surface. Further, due to the reflecting sheet the efficiency and compactness can be improved, since optics, thermal means and electronics can be all integrated in the light source. Due to the use of the reflecting sheet the interior surfaces of the tube can be arbitrarily formed.

The light source of the present invention may be used for room illumination or for example as refrigerator illumination.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

1. A light source, comprising:
a tube fixed to a first and a second end part, the tube having a lateral area, wherein a part of the lateral area comprises a light-outcoupling surface of the light source;
a first light-emitting diode mounted to the first end part;
a second light-emitting diode mounted to the second end part;
both the first and the second light-emitting diodes emitting light along a main direction of extent of the tube; and
a light reflecting sheet covering all interior surfaces of the tube except the light-outcoupling surface.

2. The light source according to claim 1, wherein the reflecting sheet comprises a silver layer.

3. The light source according to claim 1, wherein the reflecting sheet has a reflectivity of at least 95% for the light emitted by the first and second light-emitting diodes.

4. The light source according to claim 1, wherein the tube has a cylindrical or rectangular cross-section.

5. The light source according to claim 1, wherein the tube comprises a rear part carrying the reflecting sheet and a front part comprising the light-outcoupling surface, the front part being fixed to the rear part.

6. The light source according to claim 1, wherein the tube is air-filled.

7. The light source according to claim 1, wherein each of the first and the second end parts comprise a reflector-like indentation, the indentation carrying the first or second light-emitting diode.

8. The light source according to claim 7, wherein each of the reflector-like indentations is covered by the reflecting sheet.

9. The light source according to claim 1, wherein each of the first and the second end parts comprise a heat sink.

10. The light source according to claim 1, wherein the first and second end parts comprise aluminum.

11. The light source according to claim 1, wherein the tube is made of plastic or glass.

12. The light source according to claim 1, wherein the light-outcoupling surface comprises a diffusive and/or refractive sheet.

13. The light source according to claim 1, wherein each of the first and the second light-emitting diodes comprise a plurality of light-emitting diodes.

14. The light source according to claim 1, wherein each of the first and second light-emitting diodes comprise a silicone lens.

15. The light source according to claim 1, further comprising an electronic control device for controlling the at least one first and second light-emitting diodes.

16. The light source according to claim 2, wherein the reflecting sheet is a silver coated plastic foil having a reflectivity of about 99% for visible light.

17. The light source according to claim 1, wherein the tube and the first and the second end parts with the reflector-like indentation have a rectangular cross-section and the reflector-like indentations have a parabolic cross-section perpendicular to a longer side of the rectangular cross-section.

18. The light source according to claim 1, wherein the light source includes a standard T5 or T8 socket.

19. A light source, comprising:
a tube fixed to a first and a second end part, the tube having a lateral area, wherein a part of the lateral area comprises a light-outcoupling surface of the light source;
a first light-emitting diode mounted to the first end part and a second light-emitting diode mounted to the second end part, both the first and the second light-emitting diodes emitting light along a main direction of extent of the tube; and
a light reflecting sheet covering all interior surfaces of the tube except the light-outcoupling surface;
wherein the first end part comprises a reflector-like indentation that carries the first light-emitting diode;
wherein the second end part comprises a reflector-like indentation that carries the second light-emitting diode; and
wherein each of the reflector-like indentations is covered by the reflecting sheet.

20. A light source, comprising:
a tube fixed to a first and a second end part, the tube having a lateral area, wherein a part of the lateral area comprises a light-outcoupling surface of the light source, wherein the tube is air-filled and wherein each of the first and the second end part comprises a heat sink;
a plurality of light-emitting diodes mounted to the first end part and a plurality of light-emitting diodes mounted to the second end part, each of the light-emitting diodes being surface-mountable, having a silicone lens and emitting light along a main direction of extent of the tube, wherein each of the first and the second end part comprises a reflector-like indentation, the indentations carrying the pluralities of light-emitting diodes; and
a light reflecting sheet covering all interior surfaces of the tube except the light-outcoupling surface, wherein the light reflecting sheet is a silver coated plastic foil, and wherein each of the reflector-like indentations is covered by the reflecting sheet.
